(19) United States
(12) Patent Application Publication
(10) Pub. No.: US 2026/0309544 A1
(43) Pub. Date: Oct. 8, 2026

(54) Optical Detector Unit, UV Index Sensor, and Method for Multispectral Light Sensing, in particular for determining the UV Index

(71) Applicant: AMS-OSRAM AG, Premstaetten (AT)

(72) Inventor: Gunter SIESS, Kraftsdorf (DE)

(21) Appl. No.: 19/481,892

(22) PCT Filed: Apr. 16, 2024
(86) PCT No.: PCT/EP2024/060244

§ 371 Date: Nov. 6, 2025

(30) Foreign Application Priority Data
May 8, 2023 (DE) 10 2023 111 908.7

(51) Int. Cl. G01J 1/42; G01J 1/02; G01J 1/04; G01J 1/44

(52) U.S. Cl. CPC G01J 1/429; G01J 1/0492; G01J 1/4228; G01J 2001/0257; G01J 2001/4266; G01J 2001/444

(57) ABSTRACT

An optical detector unit comprising an optical sensor arranged in a chamber with an aperture in a housing is provided, said optical sensor arranged to detect received photons through the aperture, wherein said optical sensor comprises a number of sensor channels, each channel comprising a sensor pixel and an optical filter associated with said sensor pixel enabled to perform for UV Index determination at enhanced accuracy and data reliability. At least two, e.g., three, of said channels are designed as UVI measurement channels, each UVI measurement channel having a spectral responsivity with a peak wavelength between 280 nm and 370 nm.

### CROSS-REFERENCE TO RELATED APPLICATIONS

This application is a 371 U.S. National Phase of PCT International Patent Application No. PCT/EP2024/060244 filed on Apr. 16, 2024, which claims priority from German Patent Application No. 10 2023 111 908.7 dated May 8, 2023, the disclosures of which are incorporated by reference herein in their entirety for all purposes.

### TECHNICAL FIELD

The disclosure relates to an optical detector unit. The disclosure more particularly relates to an optical detector unit comprising an optical sensor arranged in a chamber with an aperture in a housing, said optical sensor arranged to detect received photons through the aperture, wherein said optical sensor comprises a number of sensor channels, each channel comprising a sensor pixel and an optical filter associated with said sensor pixel. The disclosure furthermore relates to a sensor for measuring the UV Index, comprising such an optical detector unit, and to a method for multispectral light sensing.

### BACKGROUND

Optical sensors are increasingly being used in such diverse areas of technology as smart phones and mobile devices, smart homes and buildings, industrial automation, medical technology and connected vehicles, etc. As sensor data and performance increase, more and more applications and individualized solutions become feasible, thereby increasing comfort and functionality of mobile devices such as smart phones. Currently, color and spectral light sensing on a chip-scale have various applications in color identification, data authentication, spectroscopy, and other industrial and consumer-level optical detection applications.

One future application that may be of significant interest may be the possibility to measure the UV Index in a mobile device. The ultraviolet index, or UV index, is an international standard measurement of the strength of the sunburn-producing ultraviolet (UV) radiation at a particular place and time. It currently is primarily used in daily and hourly forecasts aimed at the general public. The UV index is designed as an open-ended linear scale, directly proportional to the intensity of UV radiation, and adjusting for wavelength based on what causes human skin to sunburn. The purpose of the UV index is to help people effectively protect themselves from UV radiation, which has health benefits in moderation but in excess causes sunburn, skin aging, DNA damage, skin cancer, immune suppression, and eye damage, such as cataracts. Therefore, it may be highly desirable to empower carry-on devices such as mobile devices, mobile phones, or the like to provide real-time, on the spot information regarding the current UV Index to the user.

In view of the widespread use of optical sensors in mobile devices, expansion of their functionality to also include information regarding UV components in the detected spectrum have been considered. As an example, WO 2021/130155 A1 discloses an integrated UV radiation sensor providing, in addition to existing sensor arrays, relatively simple single detectors having a spectral responsivity of the type of a relatively narrow band filtering in the UV regime. These solutions, however, are of limited accuracy only, and due to using interference filters, may be affected significantly by the performance and the process variation of filter (device to device). Because of only one detection channel, the possible calibration is only a scaling, and the ability of estimating the UV impact on human skin for lack of correlation to the UV Index is only limited.

### SUMMARY

The object of the disclosure is to provide an improved optical detector unit of the type identified above, that helps to overcome the deficiencies identified above and provide user-friendly data that may directly be used to assess risk factors due to the effect of incoming UV radiation. Further, an improved sensor should be provided, in particular for direct use as a UV Index sensor, as well as an improved method for multispectral light sensing.

With respect to the optical detector unit, this object is achieved in that the optical sensor of the detector unit comprises a number of sensor channels, each channel comprising a sensor pixel and an optical filter associated with said sensor pixel, and wherein at least two of said channels are designed as UVI measurement channels, wherein each UVI measurement channel has a spectral responsivity with a peak wavelength between 280 nm and 370 nm.

The disclosure is based on the consideration that in order to overcome the potential deficiencies and limited abilities of existing systems, the true impact of incoming UV radiation on human skin and the risks caused thereby should be taken into account by relating the evaluation of data more systematically than before to the characteristics of the UV Index. In particular, it should be taken into account that the UV index is a number linearly related to the intensity of incoming sunburn-producing UV radiation. For proper risk assessment, however, it should not be simply related to the irradiance because the UV of greatest concern occupies a spectrum of wavelengths from 295 to 325 nm, and shorter wavelengths have already been absorbed a great deal when they arrive at the earth's surface. However, skin damage from sunburn is related to wavelength, the shorter wavelengths being much more damaging. The UV power spectrum, for determination of the UV index, is therefore multiplied by the so-called erythemal action spectrum. This result, in order to obtain the proper UV Index, is integrated over the whole spectrum, giving a weighted UV irradiance value or the erythemal dose rate. In accordance with an aspect of the disclosure, in order to obtain a useful sensor based approximation value for this risk exposure, the spectral distribution of this skin sensitivity as expressed in the erythemal action spectrum should be considered.

In order to achieve this, in an aspect of the disclosure the detector unit comprises at least two channels that are dedicated to be used for determination of a parameter approximating the UV Index, here referred to as “UVI measurement channels”. In view of the characteristics of the erythemal action spectrum in combination with the typical incoming light spectrum, in accordance with one aspect of the disclosure, each of these UVI measurement channels should have a spectral responsivity with a peak value in the relevant range between 280 nm and 370 nm. By providing at least two of these UVI measurement channels, the detector unit is able to at least to some degree to compensate for spectral effects that are relevant for the UVI value.

In some embodiments and in accordance with one aspect of the disclosure, the engineering of the spectral characteristics of the respective channels takes into account that for incoming radiation, the most relevant transmission variation with respect to its original, sun-generated spectrum comes from Rayleigh scattering and Ozone absorption. Both are different in absorption spectral shape and defining the final effective spectra and UVI numbers. Consequently, the spectral variation in the range of 280 nm . . . 340 nm may be measured in a multispectral way to distinguish between the different absorption effects or reconstruct the final effective spectra, and thus the UVI measurement channels should have peak responsivity in this range.

In particular, and in accordance with one aspect of the disclosure, a spectral reconstruction approach is used for the sensor signals produced by the UVI measurement channels in order to approximate the UV index, e.g., using peak wavelengths, FWHM and shapes well defined for at least two (e.g., two, three or four) spectral channels in the mentioned wavelength range and a procedure to reconstruct the terrestrial spectrum by the knowledge about the real spectral characteristic and from this defined individual transfer matrix.

In accordance with an aspect of the disclosure, the optical sensor further comprises a third sensor channel designed as one of the UVI measurement channels, also having a spectral responsivity with a peak wavelength between 280 nm and 370 nm. The provision of exactly three UVI measurement channels of the type defined above is considered particularly beneficial since, as explained above, the expected weighted spectral function for approximating the UV index, i.e. the product of the expected spectrum of incoming radiation with the erythemal action spectrum is a curved spectral function, rendering linear extrapolations from measurement values in the visible spectrum into the UV spectrum to only limited value. Rather, providing a set of three sensor data allows for a least a rough approximation of the curved spectrum. In some embodiments, more than three UVI measurement channels may be provided, but it was found that their additional contribution to sensor accuracy is only of limited value at significant additional cost. Therefore, in view of cost benefit ratio, some embodiments provide exactly three UVI measurement channels.

In some embodiments, the UVI measurement channels each have a spectral responsivity with FWHM between 10 nm and 30 nm.

In another aspect of the disclosure, the spectral responsivity of the UVI measurement channels is designed in such a way that data evaluation in a range of especially high significance is enabled. In accordance with this aspect of the disclosure, a first of said UVI measurement channels has a spectral responsivity with a peak wavelength at about 290 nm, and a second of said UVI measurement channels has a spectral responsivity with a peak wavelength at about 320 nm. This aspect of the disclosure, in particular, considers that at these wavelengths, the characteristics of the expected weighted impact spectrum are most significant, thereby providing the most valuable information regarding UV impact. With the design peak wavelengths chosen in this way, even merely two UVI measurement channels may be sufficient to provide valuable signals.

In yet a further aspect of the disclosure, at least three UVI measurement channels are provided, in which a first of said UVI measurement channels has a spectral responsivity with a peak wavelength at about 290 nm, a second of said UVI measurement channels has a spectral responsivity with a peak wavelength at about 305 nm, and a third of said UVI measurement channels preferably has a spectral responsivity with a peak wavelength at about 340 nm.

According to some embodiments, the pixels of the respective channels each comprise a photodiode and a filter, wherein the filter determines the transmission characteristic of the respective sensor pixel.

For proper evaluation of the individual output signals provided by the UVI measurement channels, recalibration or rescaling may be need or recommendable in order to compensate for different individual sensitivity. This, in a way is comparable to a similar multi-channel system. This aspect may be achieved with a standard calibration procedure in which under standard, equal conditions for all channels their individual responsivity may be measured, and the results used for later rescaling and compensation. This correction of the channel signals may be effected in an external control unit, or alternatively in an integrated component of the detector unit or sensor as such. In some embodiments, the detector unit further comprises an evaluation unit configured to provide an output sensor signal generated by the optical sensor and characteristic for the UV Index, wherein said output signal is calculated from individual output signals from each of the UVI measurement channels).

With respect to the multispectral sensor, the object mentioned above is achieved in that the multispectral sensor comprises an optical detector unit of the type identified above. In another aspect of the disclosure, the multispectral sensor is designed to be a UV Index sensor and intended to be used as such.

With respect to the method for multispectral light sensing, the object identified above in accordance with one aspect of the disclosure is achieved with the steps of:
detecting received photons by means of an optical sensor arranged in a chamber in a housing through an aperture of said chamber,
   wherein said optical sensor comprises a number of sensor channels, each channel comprising a sensor pixel and an optical filter associated with said sensor pixel, and wherein at least two of said channels are designed as UVI measurement channels, each UVI measurement channel having a spectral responsivity with a peak wavelength between 280 nm and 370 nm,
for each UVI measurement channel generating a UVI measurement channel signal, and
generating an output sensor signal of the optical sensor and characteristic for the UV Index from the UVI measurement channel signals of each of said UVI measurement channels.

The method may further comprise the step of spectral reconstruction of the UVI measurement channel signals by an associated calibration vector or individually assigned correction values for each of the UVI measurement channels before the output sensor signal of the optical sensor characteristic for the UV Index is generated.

In an aspect of the disclosure, the concept as defined above is used in an application for UV Index determination, e.g., in mobile device applications.

In one aspect of the disclosure, a mobile device, in particular, e.g., a smart phone, comprises an UV Index sensor having an optical detector unit of the type identified above.

The major advantages achieved by the embodiments may be seen in that due to the provision of at least two, e.g., three, dedicated UVI measurement channels, a real-time, on the spot indicative value for the UV index may be provided with much higher accuracy and reliability than in previous systems, and therefore the user will be enabled to receive an improved information regarding the current risk factors due to impact of incoming UV radiation. By incorporation of a sensor based upon this concept into a mobile device, in particular a smart phone, a carry-on solution for managing the risk of UV exposure for the user may be provided.

### BRIEF DESCRIPTION OF THE DRAWINGS

Various embodiments and aspects of the disclosure are described further in connection with a drawing. In this drawing,

FIG. 1 shows a part of a mobile device, in particular a smartphone,

FIG. 2 shows an optical detector unit of the mobile device of FIG. 1 in cross section,

FIG. 3 shows a number of graphs for determination of the UV index,

FIG. 4a, 4b shows a number of graphs indicating the effects of scattering on the sunlight spectrum, and

FIG. 5 shows a number of graphs representing the relative spectral responsivity of UVI measurement channels of the detector unit of FIG. 2.

Identical parts are labelled by the same reference numerals.

### DETAILED DESCRIPTION

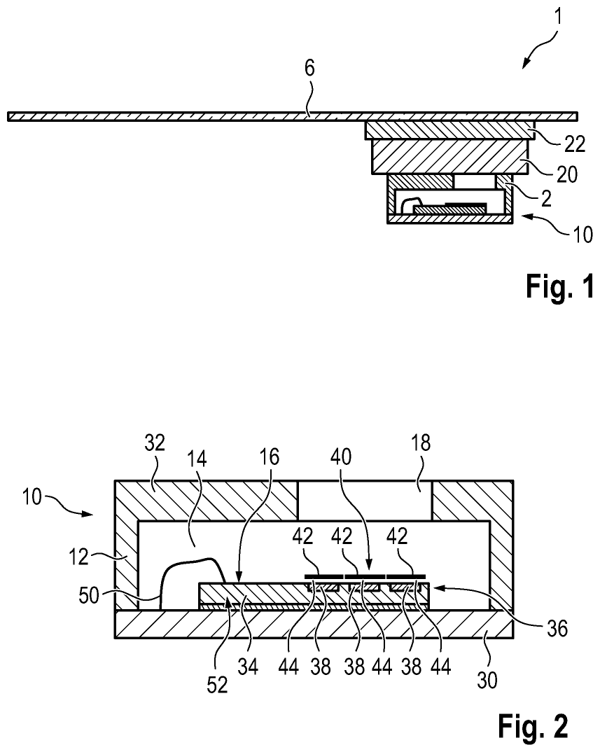

FIG. 1 shows a part of a mobile device 1. In the embodiment, a smart phone is shown in cross section. The mobile device 1, as a result of striving for superior functionality and versatility, among other typical and conventional features and applications, comprises a UV Index sensor 2 as part of an integrated system that provides any type of adequate information regarding the current UV Index situation to the user. The type of information provided to the user within this functionality may be an approximate value of the current UV Index as determined by the system, and/or a risk factor indicating the risk of skin damage, sunburn, or the like to the user, and/or a general warning message containing recommendations to the user, such as not to expose skin to avoid enhanced risk of sunburn at the moment.

For this purpose, the UV Index sensor 2, potentially together with various other components, is mounted at the back of a cover glass 6, which may be the cover glass 6 of the smartphone 1 as such. The UV Index sensor 2. The UV Index sensor 2 comprises an optical detector unit 10 in the form and design of an optical sensor chip. It is noted that the concept proposed herein can be applied for various types of optical sensor chips and optical devices and that the present disclosure relates to the design of the optical detector unit 10 alone and therefore may very well be used in an optical detector unit 10 in other configurations. In particular, it is noted that in the embodiment shown, the optical detector unit 10 is designed as separate, stand-alone sensor component; in alternative embodiments, however, existing, conventional sensor chips may also be expanded in their functionality to also include the capabilities of providing UV Index measurements by adding individual technical features or components in accordance with the concept described below.

The optical detector unit 10 of the UV Index sensor 2 as shown in FIG. 2 comprises a housing 12 with a sensor chamber 14 in which the actual UV Index sensor unit 16 is positioned. In order to allow for proper passage of light or radiation to reach the sensor unit 16 through the housing 12, the housing 12 is provided with an opening or aperture 18. The aperture 18 may be covered by a VIS and NIR cut filter 20, which in turn, depending on the exact positioning and design of the components, may be covered by a diffuser 22. In the embodiment shown, the diffuser 22 is positioned directly adjacent to the cover glass 6.

As shown in FIG. 2, the housing 12 of the detector unit 10 is arranged on a substrate or carrier 30. A cover section or lid 32 forming the aperture 18 and also part of the housing 12, is located opposite to the carrier 30 and thereby covers the chamber 14. The carrier or substrate 30 provides mechanical support and electrical connectivity to electronic components which are integrated into the optical detector unit 10. For example, the carrier 30 may comprise a printed circuit board, PCB (not shown). However, in other embodiments (not shown) the carrier 30 can also be part of the housing 12, and electronic components may be embedded into the housing 12 by molding for example.

As part of the optical detector unit 10, the optical sensor unit 16 is arranged inside the chamber 14 and on the carrier 30. In this particular embodiment, the optical sensor 16 is integrated into a single semiconductor sensor die 34 together with other electronics. The optical sensor comprises an arrangement 36 of individual optical detector elements or pixels 38 which will be discussed in further detail below. The pixels 38 may be implemented as photodiodes, for example. As further part of the optical detector unit 10, an arrangement 40 of optical filters 42 is arranged in the chamber 14 above the optical sensor unit 16. The arrangement 40 of optical filters 42 is attached to the optical sensor 16. The pixels 38 each are associated with an associated optical filter 42 having a different transmission characteristic. Together, the pixels 38 and associated filter 42 form a channel 44 of the optical detector unit 10. The optical filters 42 may be interference filters such as an optical cut-off filter, bandpass, long or short pass filter, dielectric filters, Fabry-Perot filters and/or polymer filters. The spectral sensitivity or responsivity of each channel 44 be achieved by the individual design of the respective optical filter 42 in combination with their associated pixels 38, e.g. based on appropriate design of the interference filters. The filters 42 can be designed or engineered so that each sensor pixel 38 and the respective channel 44 has its own spectral sensitivity.

In order to allow for proper passage of light or radiation, the cover or lid 32 of the housing 12 is provided with the aperture 18. The aperture 18 is positioned above the optical sensor 16. In fact, the aperture 18 lies within a field of view (FOV) of the optical sensor 16. The field of view of the optical sensor 16 includes all points in space from where, at least theoretically, light radiated from an external radiation or light source may traverse towards the optical sensor 16, e.g. for a fixed detector position and orientation.

In the embodiment shown, a control unit 50 and a measurement unit 52 are integrated into the semiconductor sensor die 34 alongside with the optical sensor 16. The measurement unit 52 can be considered a control unit for the optical detector unit 10. For example, it provides sensor signals which are generated by the optical sensor 16. The control unit 50 and measurement unit 52 may be implemented as control logic, state machines, microprocessor and the like. They may also comprise additional components such as analog-to-digital converters, time-to-digital converters, amplifiers which too are located in the semiconductor sensor die 34. The semiconductor die 34 may have a printed circuit board PCB providing electrical communication to the individual components of the multispectral sensor. It is well understood, however, that in alternative embodiments, some or all of the functionalities provided by the control unit 50 and/or the measurement unit 52 may be performed in other control units or control logic external to the detector unit 10.

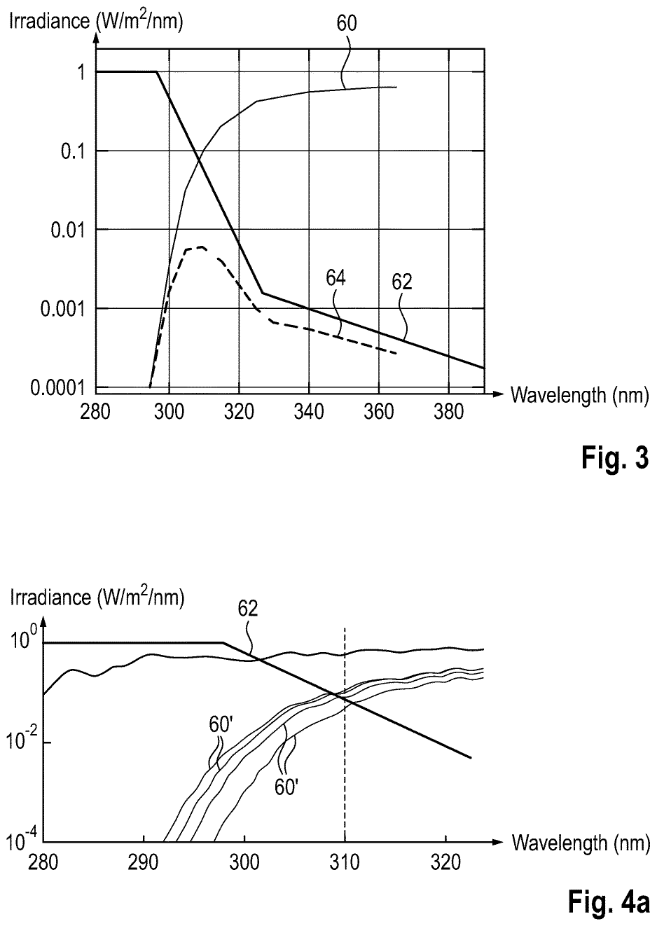

The detector unit 10 is designed and engineered to enable the UV Index sensor 2 to provide a parameter characteristic for the so-called UV index, in particular for further processing in order to provide characteristic information of the type identified above, in particular a quantitative value of the current UV index and/or messages or other parameters derived therefrom. In view of this design goal, the detector unit 10 is designed for picking up information of particular relevance for the determination of the UV index. For further explanation of the background considerations, FIG. 3 shows a number of graphs showing the relevant background information for determining the UV index.

In FIG. 3, graph 60 shows, in logarithmic scale, the irradiation by sunlight spectrum, as a function of wavelength. Graph 62 is, in regular scale, the so-called erythemal action spectrum as a function of wavelength, identifying, in general terms, the intensity of human skin reaction to exposure of UV irradiation. Graph 64 is the result of multiplication of graphs 60 and 62, showing, in logarithmic scale, the effective spectrum relevant for assessing the risk of damaging the human skin as a consequence of irradiation by the sunlight spectrum. This effective spectrum as represented by graph 64, in general and as used in public services, e.g., is the basis for calculation of the UV Index. As becomes evident from FIG. 3, the main and mostly significant contributions from the effective spectrum as represented by graph 64 are within a wavelength range between about 290 nm and 370 nm.

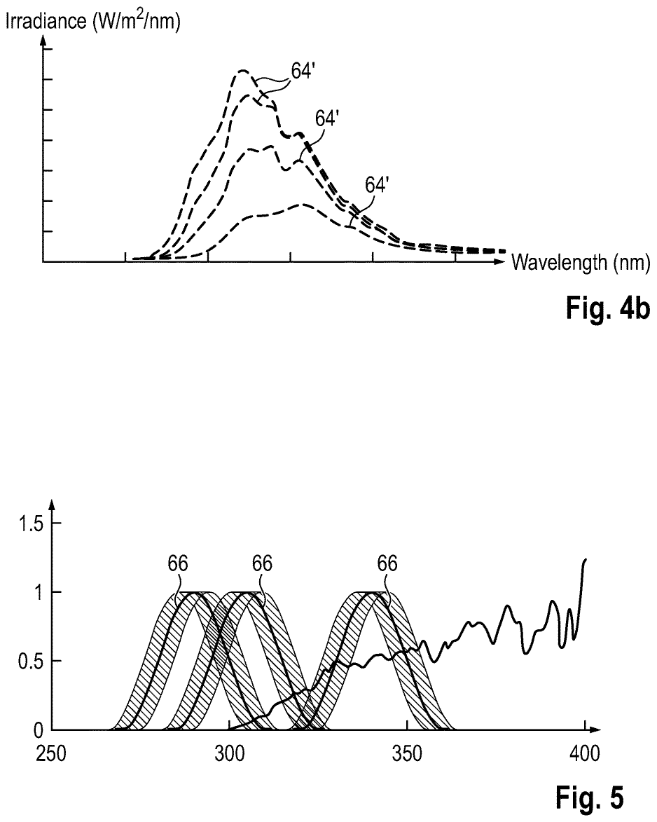

In actual situations, however, the sunlight spectrum as efficiently reaching the human skin, or, equivalently, the detector unit 10, may be due to variations due to ambient conditions. Main sources of changes to the sunlight spectrum may be seen in the effects of Rayleigh scattering and Ozone absorption in the atmosphere, both resulting in reduced transmission for lower wavelengths. FIG. 4 shows a number of graphs showing, in logarithmic scale, several graphs 60′ representing the sunlight spectrum under various scattering conditions (FIG. 4a) and, resulting therefrom, after multiplication with the erythemal action spectrum, several graphs 64′ representing the effective exposure spectrum under the same various scattering conditions. Evidently, as may be seen from these graphs 64′, variations in ambient conditions may have significant effects on proper calculation of the UV Index. These effects of scattering on the incoming light spectrum are considered one major source of insufficient performance of previous UV Index sensors.

In order to overcome these deficiencies of previous UV Index sensors, the optical detector unit 10 of the UV Index sensor 2 as shown in FIG. 2 is designed for potential compensation of such variation effects. In order to achieve this, according to an aspect of the present disclosure at least two, channels are provided, the channels 44 are designed as special purpose channels 44, namely as UVI measurement channels 44. In some embodiments, exactly three channels are provided. In an aspect, each such UVI measurement channel 44 shall be understood to be characterized by a spectral responsivity with a peak wavelength between 280 nm and 370 nm.

Further, in the embodiment shown, the UVI measurement channels 44 each have a spectral responsivity with FWHM between 10 nm and 30 nm.

FIG. 5 shows graphs 66 representing the relative spectral sensitivity or responsivity of the three UVI measurement channels 44 of the optical detector unit 10. As shown, a first of the UVI measurement channels 44 has a spectral responsivity with a peak wavelength at about 290 nm, a second of the UVI measurement channels 44 has a spectral responsivity with a peak wavelength at about 305 nm, and the third of the UVI measurement channels 44 has a spectral responsivity with a peak wavelength at about 340 nm.

Since the individual responsivities of the channels 44 may vary due to variations in the production process and the like, in order to assign each channel 44 appropriate weight when calculating an approximate value of the UV index, appropriate corrections to the individual sensor outputs might be necessary or desirable. Accordingly, the integrated evaluation or measurement unit 52 may be configured to provide an output sensor signal generated by the optical sensor 16 and characteristic for the UV Index, wherein this output signal is calculated from individual output signals from each of the UVI measurement channels 44, each may be modified by appropriate weight factors obtained from a previous calibration measurement of the individual channels 44.

In some embodiments, in particular to be able to obtain reliable sensor signals independent from potential spectral noise, a Gaussian shape (FWHM 10 . . . 30 nm) of the filter 42 or the responsivity of the complete UVI measurement channel 44 is provided. In the embodiment shown in FIG. 5, channels 44 with 20 nm FWHM are provided.

As mentioned above, in accordance with one aspect of the disclosure and in favour of a specifically simple configuration, a system with only two UVI measurement channels 44 may be chosen. In all embodiments, a channel peak wavelength between 290 nm and 340 nm may be selected. A setup with two UVI measurement channels 44 may be beneficial to compensate offset and tilt but not to change of convex distortion. Therefore, three or more UVI measurement channels 44 may be provided.

The UVI measurement channels 44, in the selected range of wavelengths, may be distributed regularly, or, as shown in the embodiment, in an optimized design with peak wavelengths at about 290 nm, 305 nm, and 340 nm, respectively to obtain superior performance in reconstruction and finally UVI calculation from this reconstructed spectrum. Further, more than three UVI measurement channels may be provided but the additional channels are not expected to increase the accuracy of the system significantly.

The sensor unit 16 described herein may be provided in an integrated multi spectral sensing device (CMOS and/or on top interference filter). In general, the design and concept of the UV Index sensor 2 provides potential for particularly high accuracy UVI measurement independent from precious filter process variations, in particular by way of compensation of spectral filter variation by individual calibration. The compensation parameters may be provided by memory devices in the sensor system, or alternatively be supported by Chip-Id via cloud systems. The design concept further may allow for high quality, potentially even perfect, spectral reconstruction in the effective and relevant spectrum range, resulting a high accuracy in UVI calculation even taking into account the spectral effects by Ozone absorption and/or Rayleigh scattering. An improved measurement concept of this type further allows to calculate various UV parameters like Vitamin D3 production, DNA skin damage, Eye damage, or the like.

The embodiments of the optical sensor device 1 discussed herein have been disclosed for the purpose of familiarizing the reader with various aspects of the disclosure. Although embodiments have been shown and described, many changes, modifications, equivalents, and substitutions of the disclosed concepts may be made by one having skill in the art without unnecessarily departing from the scope of the claims.

In particular, the disclosure is not limited to the disclosed embodiments, and gives examples of as many alternatives as possible for the features included in the embodiments discussed. However, it is intended that any modifications, equivalents, and substitutions of the disclosed concepts be included within the scope of the claims which are appended hereto.

Features recited in separate dependent claims may be advantageously combined.

Furthermore, as used herein, the term “comprising” does not exclude other elements. In addition, as used herein, the article “a” is intended to include one or more than one component or element, and is not limited to be construed as meaning only one.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

LIST OF REFERENCE NUMERALS

| | |
|---|---|
| 1 | mobile device |
| 2 | UV Index sensor |
| 6 | cover glass |
| 10 | optical detector unit |
| 12 | housing |
| 14 | chamber |
| 16 | sensor unit |
| 18 | aperture |
| 20 | IR cut filter |
| 22 | diffuser |
| 30 | substrate |
| 32 | lid |
| 34 | sensor die |
| 36 | arrangement |
| 38 | pixel |
| 40 | arrangement |
| 42 | optical filter |
| 44 | channel |
| 50 | control unit |
| 52 | measurement unit |
| 60, 62, 64, | graph |
| 60′, 64′, 66 | |

1. An optical detector unit comprising an optical sensor, wherein said optical sensor comprises a number of sensor channels, each channel comprising a sensor pixel and an optical filter-associated with said sensor pixel, and wherein at least two of said channels are designed as UVI measurement channels, each UVI measurement channel having a spectral responsivity with a peak wavelength between 280 nm and 370 nm.

2. The optical detector unit of claim 1, wherein said optical sensor comprises a third sensor channel designed as UVI measurement channel, having a spectral responsivity with a peak wavelength between 280 nm and 370 nm.

3. The optical detector unit of claim 1, wherein said UVI measurement channels each have a spectral responsivity with FWHM between 10 nm and 30 nm.

4. The optical detector unit of claim 1, wherein a first of said UVI measurement channels has a spectral responsivity with a peak wavelength at about 290 nm and a second of said UVI measurement channels has a spectral responsivity with a peak wavelength at about 320 nm.

5. The optical detector unit of claim 4, wherein a third of said UVI measurement channels has a spectral responsivity with a peak wavelength at about 340 nm.

6. The optical detector unit of claim 1, further comprising an evaluation unit configured to provide an output sensor signal generated by the optical sensor and characteristic for the UV Index, wherein said output signal is calculated from individual output signals from each of said UVI measurement channels.

7. A multispectral sensor, comprising the optical detector unit of claim 1.

8. A UV-Index-Sensor, comprising the optical detector unit of claim 1.

9. A method for multispectral light sensing, comprising the steps of:
detecting received photons by means of an optical sensor arranged in a chamber in a housing through an aperture of said chamber,
wherein said optical sensor comprises a number of sensor channels, each channel comprising a sensor pixel and an optical filter associated with said sensor pixel, and wherein at least two of said channels are designed as UVI measurement channels, each UVI measurement channel having a spectral responsivity with a peak wavelength between 280 nm and 370 nm,
for each UVI measurement channel generating a UVI measurement channel signal, and
generating an output sensor signal of the optical sensor and characteristic for the UV Index from the UVI measurement channel signals of each of said UVI measurement channels.

10. The method for multispectral light sensing of claim 9, further comprising the step of spectral reconstruction of the UVI measurement channel signals by associated calibration values before the output sensor signal of the optical sensor characteristic for the UV Index is generated.

11. Use of the method of claim 9 in an application for UV Index determination.

12. A mobile device, comprising an UV Index sensor having an optical detector unit of claim 1.
